(19) United States
(12) Patent Application Publication
(10) Pub. No.: US 2004/0267575 A1
(43) Pub. Date: Dec. 30, 2004

(54) Method and system for monitoring medical examination and/or treatment activities

(76) Inventor: Dieter Boing, Muhlhausen (DE)

Correspondence Address: SCHIFF HARDIN, LLP, PATENT DEPARTMENT, 6600 SEARS TOWER, CHICAGO, IL, 60606-6473, US

(21) Appl. No.: 10/833,920

(22) Filed: Apr. 28, 2004

(30) Foreign Application Priority Data
Apr. 28, 2003 (DE) 103 19 085.6

(51) Int. Cl. G06F 17/60

(52) U.S. Cl. 705/3; 705/2

(57) ABSTRACT

In a method and medical system for monitoring examination and/or treatment activities embodying a number of different work processes and regarding a specific patient, wherein a medical system has a number of networked modalities., time data are determined for the individual modalities as to the starting point and/or the duration of a planned work process, on the estimated remaining time for a work process that has already started, and the finish of the concerned work process, at the respective modalities using time ascertainment units. A personal time lapse plan assigned to the patient in question is then created for graphical output based on the determined time data.

### BACKGROUND OF THE INVENTION

1. Field of the Invention

The present invention concerns a procedure for monitoring examination and/or treatment activities embodying a number of different work processes regarding a specific patient In a medical system with a number of networked modalities. The invention also concerns a medical system with a number of networked modalities for the implementation of examination and/or treatment activities, each of which embodies a number of work processes.

2. Description of the Prior Art

Examinations using modern examination equipment, e.g. computed tomography devices, X-ray devices, magnetic resonance devices, ultrasound devices, etc., and/or treatments using treatment equipment, e.g. a radiation therapy device or a nuclear medicine device—in general also called modalities—generally require a number of subsequent or to some extent even parallel-occurring work processes. For example, the required image data is first recorded with a computed tomography system itself for a computed-tomography examination. After this “image data acquisition,” processing of the recorded image data in several steps takes place, in particular a reconstruction of individual images or image series. Then, generally, the data are automatically sent to a workstation, where the images can be viewed by the doctor. At the same time, the image data are often sent to a mass storage device for archiving. Additionally, different three-dimensional reconstructions can be created from the obtained Image data through a data reprocessing process. Furthermore, films of the reconstructed images can be created at a “filming station” in order to also archive the images in film form or to send them to an after-treatment physician or to give them to the patient The below use of term “examination” not only means the creation of Images using the respective modality, i.e. pure image acquisition, but also the complete examination including the processing of all image data and the associated reconstruction, filming, data transfer, and other work processes,

In larger clinics or radiological practices, in which several modalities are networked to create a medical system, generally a number of patients are examined in parallel with the different modalities, and some patients also must be examined with several modalities for later diagnosis. In particular, such a system requires the best possible coordination of the individual work processes in order to keep the times for the different examination events as short as possible. This is in the interest of the patient, since the waiting times are thus shorter. The technical equipment as well as the required personnel, i.e. MTRA (medical-technical radiology assistants) and doctors, also can be better and more uniformly occupied. This type of “workflow optimization” first requires a simplification and, to the extent possible, an automation of the individual work processes. This can lead to channeling all of the concentration of the personnel to the patients and less to the control of the work process surrounding the patients.

There are already many reasons to unburden to the greatest extent possible the personnel in the operation of devices through more comfortable user interfaces in order to enable the user to pay more attention to the patient during the examination. For example, German OS 198 24 496 describes a device, in particular for controlling the X-ray tubes of a CT device, that graphically depicts the value for which certain operating parameters are effective during an activation phase on a display device in the form of rectangles arranged across a time axis In this manner, the operator can control the device setup much more quickly using the displayed graphical samples than when reading a table, for example.

Moreover, German OS 101 14 017 describes process management using a workflow machine for clinical and radiological processes for the improvement of the workflow within a clinic. Time planning, however, takes place manually immediately following the entry of an order by specially provided medical technicians at special time planning workstations. A very fast and flexible reaction by the system in particular with unforeseeable incidents or other delays is thus often not possible in this system

It should be taken into consideration that generally the clinical handling of patients cannot be planned exactly. For example, emergencies cannot be planned. Such incidents sometimes have serious effects on existing planning. In some cases, work processes that have already begun, which can last several minutes, are halted and instead other actions are started in order to take life-saving measures for an emergency patient. It may also become necessary during the examination of a patient to expand the examination. Above all, during image data acquisition with the modality itself or during the reconstruction of the data, occurring events or delays accordingly affect the subsequent work processes so that in some cases a complete reorganization of the examination processes may be necessary. In particular, this also concerns the time planning of doctors, who eventually evaluate the created images and meet with the patients. It is particularly irritating if, for example, the doctor has planned a certain timeframe for the diagnosis and for the appointment with the patient, the patient has already arrived, and the necessary data or images are not yet available at that time.

### SUMMARY OF THE INVENTION

An object of present invention is to provide a suitable procedure for monitoring the examination and/or treatment activities in a medical system of the aforementioned type, which enables at all times a current overview of the status of the entire examination or treatment process as well as the estimated duration until the completion of the individual work processes for a specific patient, and to provide a medical system, which allows this type of monitoring of the examination or treatment processes.

This object is achieved in accordance with the present invention in a method and medical system of the type initially described, wherein time data as to the starting point and the duration of a planned work process, the estimated remaining time of a work process that has already begun, and the finishing point of the work processes in question are determined automatically for each of the individual modalities with the help of time ascertainment units. Based on the determined time data, a personal time lapse plan assigned to the patient in question is created for a graphical output. This time lapse plan then can be displayed using any display device, e.g. on the monitor of the modality or on a monitor workstation, i.e. at a workstation connected to the system in the doctor's office. Furthermore, it is also possible to save the time lapse plan as well as the data based on this time lapse plan in order to later print the personal time lapse plan or to create statistics etc. using the time data.

A medical system based on the invention requires a number of time ascertainment units in order to automatically determine the corresponding time data for the individual modalities. The system also requires a time visualization device in order to create the personal time lapse plan based on the determined time data and to make available a graphical version. Moreover the medical system also requires a suitable display device for the graphical display of the time lapse plan. The modality display already available or the monitors of the workstations usually connected to such a medical system can be used as the display devices.

Using the monitoring process in accordance with the invention or in a medical system in accordance with the invention, it is always possible for personnel to check the status of the examination process for each individual patient and to determine which process step is currently occurring in the examination procedure, in particular to determine which work processes are already complete and how long the already-begun work processes will still take or when the entire examination process will be finished. The responsible radiologist thus can easily determine when the required document will be available for the diagnosis and for the patient appointment. This preferably will avoid the need for phone calls between the different stations within a clinic or larger radiological practice in order to inquire about the location of patient or the location of already reconstructed images or how long it will still take for certain patient images to be available at a workstation or in film form. All of this information can be displayed for clinical personnel In a clear and concise manner.

There are different options for the specific structure of the time ascertainment units and the time visualization device and the communication between these functional parts of the system.

It is preferred for individual time ascertainment units to be assigned to each of the different components (also referred to as “applications” below) of the individual modalities that perform the work processes. Generally, these applications are hardware and/or software modules, e.g. a module, which performs the actual data acquisition—called image data acquisition below—for the later reconstruction of the images; a networking module, which is responsible for the transmission of the acquired data to a specific workstation or storage unit; a filming module, which creates films from the image data; or a reconstruction module, which reconstructs the images from the acquired data. The time ascertainment units are preferably software modules, e.g. in the form of sub-routines of the applications.

The time ascertainment units determine for each appropriate application the required time data and send these on to the time visualization device, which creates the personal time flow from the time data for the graphical display.

For this, the medical system can be constructed such that a time visualization device is connected to a central server of the system and all time ascertainment units of all modalities send their time data to this central time visualization device The personal time lapse plan of the patient, which can in turn preferably be queried by all connected image processing devices or modalities with image processing functionality, is then created on the central server so that medical personnel always has access to this information from all locations.

In addition to this type of central server-client system, it is also possible to construct the medical system in a decentralized manner. In a preferred system of this type, individual time visualization devices are implemented on each of the different modalities. These time visualization devices can receive independent of each other the time data of the time ascertainment units on their own modality as well as the time data from the time ascertainment units of the other modalities. The system can thereby be constructed such that the time ascertainment units each transfer the time data to the time visualization device of their own modality, and the time visualization device of the different modalities communicate amongst each other to exchange the time data.

The time visualization device is also preferably implemented in the form of software modules on the individual modalities or on specific computers of the medical system.

The time lapse plan preferably is updated at different points in time. In a preferred embodiment, the time visualization device sends time query signals to the assigned time ascertainment units—e.g. at regular intervals—in order to initiate the determination of the newest time data. Alternatively, the time ascertainment units themselves can send the new time data to the associated time visualization device as soon as something changes with respect to the planned time data. A combination of both processes is also possible.

The methodology, with which the individual time ascertainment devices determine the time data for associated work processes, depends on the type of time data as well as the type of work processes. For example, it is relatively easy to record the end point of a work process or even the starting point of an already completed work process. In contrast, it is harder to calculate the estimated time left to complete an already started work process or the duration of a planned work process.

For example, the time for the transfer of the images can be calculated or estimated relatively exactly when taking the network load and the data volume into consideration. The duration of a save procedure, i.e. a burn or write process onto a hard-drive, also can be calculated almost exactly in advance based on the number of images to be saved and the associated data volume. The same is true for filming processes, where the total time for the filming process can be determined relatively easily based on the number of images. The number of sheets of film, the network transfer time, and the print times are determined there mainly from the resulting data volume and the selected film formats.

The times for the image data acquisition, i.e. for the actual patient examination, as well as the reconstruction times and post-processing times are harder to determine. In particular, for these processes, the estimated duration of a planned work process and/or the estimated remaining time for a work process that has already begun is estimated based on the times required for a number of already completed similar work processes. Thus, in this respect, “learning” systems are employed as time ascertainment units. In this manner, a representative value can be formed for a computed tomography examination, e.g. from the last 20 to 30 similar examinations performed, for example, thorax or abdomen examinations. Fixed times can be set for the admission and discharge of the patient. Learning systems, which determine an average value e.g. from the last 5 or 10 performed applications and use this average value to estimate the duration of the upcoming work process, also can be used in reconstruction or post-processing. The starting point of a planned work process is determined by the work processes for the patient or for other patients who are still waiting for the availability of the modality or application that is to perform the work process. The starting point is determined by when the preceding work processes within the examination process itself are finished.

In a preferred embodiment, in addition to the time data, other signals concerning other parameters that have an effect on the time lapse are also sent to the time visualization device from the modalities. Thus, it is preferred that an error status signal be sent to the time visualization device if an error occurs at a modality or at on one of the modality components performing the corresponding work processes. Such an error can be an error in the device or in the associated application of the device, so that this is not available or is only available in a limited manner for the specific work process. For the modalities that perform the image acquisition, however, the error may concern a “failure” on the part of the patient, i.e. the patient, for whatever reason, cannot be examined further. The preparation of the time lapse plan for the graphical display preferably takes place such that an overview over several, preferably all, work processes is displayed for the subsequent graphical display on a first graphical interface, i.e. the user can view all examination activities. Upon the request of the user, e.g. a mouse-click on the appropriate locations in the overview representation, further graphical interfaces with detailed information on a specific work process or a group of work processes are displayed.

Insofar as appropriate display devices that allow the opening of several windows in parallel are used, the different graphical interfaces can be displayed at the same time as the overview and the detailed information.

The user preferably has the option of configuring the interface or the graphical output. This can includes configuration of the representation, e.g. color selection, the type of display, etc. The user also can determine which graphical interface to use to start the display, e.g. whether he/she always wants to see the detailed information for a specific work process and only then, after an appropriate selection, wants to see the overview of all work processes. This means that the specification for the representation of the additional graphical interfaces with the detailed information on specific work processes takes place in advance within the framework of a configuration of the output by the user.

In a preferred embodiment, the graphical representation of the time lapse plan can be adjusted for the type of examination device used. i.e. the modality, with which the image data was acquired. The time lapse plan is thereby adjusted, for example dependent on whether the examination is an ultrasound examination, a computed tomography examination, a magnetic resonance examination, or a simple X-ray exam, since the subsequent work processes also change depending on the specific type of image data acquisition. The adjustment of the time lapse plan also can take place based on the type of examination, for example by taking into consideration whether the examination is a thorax examination, an abdomen examination, etc., since different subsequent work processes are required not only based on the modality or the type of data acquisition, but also based on the type of examination.

### DESCRIPTION OF THE DRAWINGS

FIG. 1 is a schematic diagram of the system architecture of a medical system in accordance with the invention, in a first embodiment.

FIG. 2 is a detailed block diagram of a time visualization device in accordance with the invention,

FIG. 3 is a block diagram for explaining the interaction between a time visualization device and different applications on a modality in accordance with the invention.

FIG. 4 is a schematic diagram of the system architecture of a second embodiment of a medical system in accordance with the invention.

FIG. 5 shows a graphical interface for the representation of an overview over the entire time lapse plan of a patient examination in accordance with the invention.

FIG. 6 shows a graphical interface for a detailed display of a certain first work process within the course of the examination in accordance with FIG. 5

FIG. 7 shows a graphical interface for the detailed display of a certain second work process within the course of the examination in accordance with FIG. 5.

FIG. 8 shows a graphical interface for the detailed display of a certain third work process within the course of the examination in FIG. 5.

### DESCRIPTION OF THE PREFERRED EMBODIMENTS

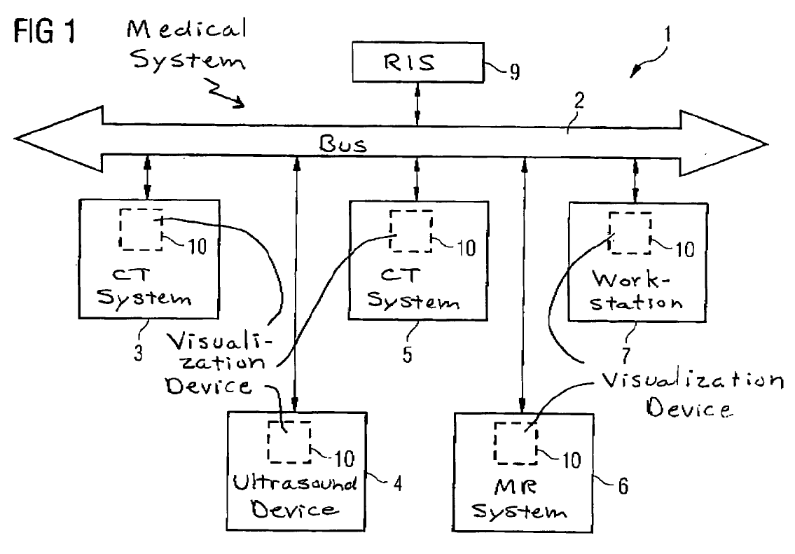

The system architecture depicted in a simplified block diagram in FIG. 1 is a medical system 1 in accordance with the invention, which is designed in a decentralized manner. Different modalities—specifically, two computed tomography systems 3, 5, a magnetic resonance system 6, and an ultrasound examination device 4 as well as a workstation 7 are interconnected via a bus 2.

Moreover, part of this medical system is also a conventional radiological information system (RIS) 9, which is also depicted here in the form of a block connected to the bus 2. Above all, this RIS 9 serves to exchange purely administrative data for patient management, ranging from the patient acceptance via the scheduling of the individual exam rooms and examination devices through to invoicing aids for the administration.

Generally, the examination requirements for the individual patients are already contained in the RIS and these examination requirements are transferred to the individual modalities, i.e. the specific modality is “booked” (reserved) for the patient in question. The medical system 1 also can have any number of further modalities, workstations, servers, or other components, such as printers, mass storage devices, etc.

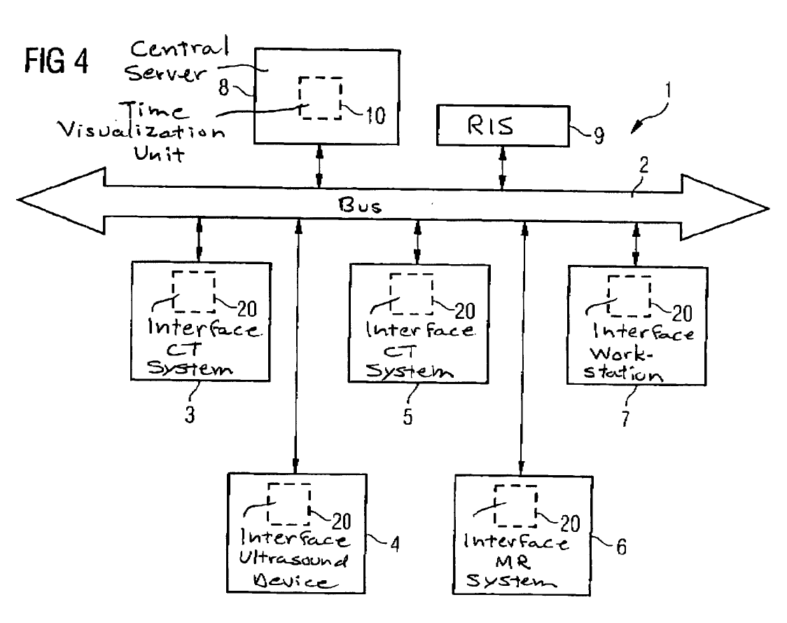

Time visualization devices 10 in the form of software modules, which receive time data from the individual modalities 3, 4, 5, 6 as to the starting point and the duration of a planned work process, the estimated remaining time of a work process that has already begun, and the finishing point of the work process in question, and create from this a personal time lapse plan assigned to a specific patient for graphical output, are implemented in workstation 7 as well as in modalities 3, 4, 5, 6. One option for specifically designing the graphical output is explained using FIG. 4 through 9.

These time visualization devices 10 at the different modalities 3, 4, 5, 6 or workstation 7 can communicate with each other via the bus 2, so that the time data of all modalities can be available or can be processed on all time visualization devices 10. This enables viewing of a patient from all connected devices, in which such a time visualization device 10 is integrated, regardless of the station, i.e. from which modality 3, 4, 5, 6 or workstation 7, from which the query takes place

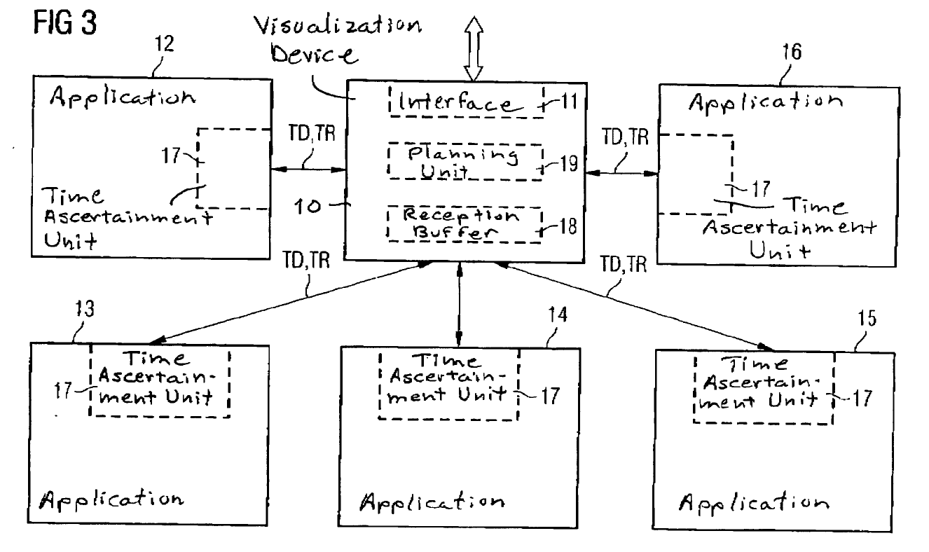

FIG. 3 is a basic schematic diagram of the structural design and the dataflow within such a time visualization device 10. The time visualization device 10 here has a reception buffer 18, a planning device 19, as well as an interface 11 for data exchange with other time visualization devices 10 in the system 1.

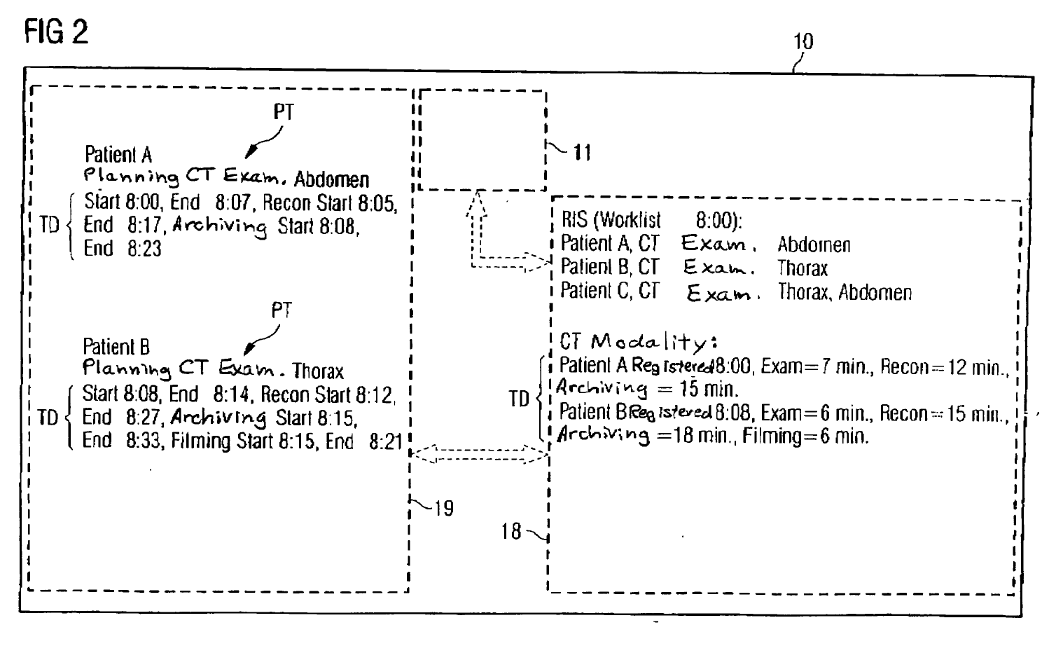

In the embodiment depicted in FIG. 2 that is displayed in conjunction with FIG. 3, the reception buffer 18 receives at a specific point in time—here at 8:00 am—first the data from the RIS 9 in the form of a so-called “work list” e.g. in DICOM format, This work list contains the information that certain examinations are to be performed on certain patients A, B, C, for example, CT examinations of the abdomen and/or the thorax. Moreover, the reception buffer 18 receives the Information from the individual modalities—here from a CT modality 3 or from the applications running on it—that the patient A is already registered, that the exam is scheduled to begin at 8 am, and that the image data acquisition (examination) will take an estimated 7 minutes, the reconstruction 12 minutes, and an archiving of the image data 15 minutes. The reception buffer 18 also receives the information that the patient B was registered at the concerned modality, that the patient exam began at 8:08 am and that image data acquisition will take an estimated 6 minutes, the reconstruction 15 minutes, and the archiving 18 minutes. The reception buffer 18 also receives the information that a filming is planned, which requires about 6 minutes.

The aforementioned data are all transferred from the reception buffer 18 to the planning unit 19, which is a software sub-routine of the time visualization device 10 with the Interface 11 and the reception buffer 18. This planning unit 19 creates a plan for each of the patients based on the data transmitted from the reception buffer 18 in the form of a patient-specific table PT. As an example, FIG. 2 shows two PT tables for patients A and B

Generally, such a patient-specific table PT is created from the named work list, which is e.g. transmitted here from RIS 9. Data from only locally registered patients e.g. in emergency situations, also can be entered and managed at each modality. This occurs automatically as soon as the modality registers a new patient for examination, with the starting point being simultaneously communicated. The data for the course of an examination of an exam selected by a certain operator are then summarized with all necessary processing and workflow activities.

The preparation of the individual pieces of information within the planning device 19 of the time visualization device 10 takes place in the current embodiment as follows:

First, the durations of the individual examinations including the selected reconstruction, post-processing, and archiving orders are transmitted. The patient stay durations, i.e. the positioning of the patient until de-positioning as well as the time for the creation of all image series and their transfer, are determined from this information. The time visualization components 10 can integrate each new piece of information from any patient into the associated personal time lapse plan and continuously update the available time data. Thus, the duration of a specific patient examination including all of the associated work processes can be calculated for each modality are created for each patient and an extremely thorough time lapse plan can be created for each patient.

The time visualization device 10 receives the required time data in the depicted embodiment via time ascertainment units 17, which are assigned to the individual applications 12, 13, 14, 15, 16, which perform the actual work processes on the modalities (see FIG. 3). These applications 12, 13, 14, 15, 16 installed at a specific modality are e.g. software modules that control certain physical components of each modality e.g. the X-ray source and detector during image data acquisition or the camera during filming etc., and process data. The time ascertainment units 17 each can be sub-modules of these applications 12, 13, 13, 15, 16. The individual applications are e.g. an application 12 for image data acquisition, i.e. for the performance of the actual image capturing on the specific modality in order to create an application 13 for saving the gathered image data on a local medium, a reconstruction application 14, a post-processing application 15, and a filming application 16 to create films from the image data. Moreover, the modality can have additional applications, e.g. a network application that is responsible for transferring the image data over a network to a mass storage device of a medical system or to specific workstations. The modality does not necessarily need to have all of these different applications For example, several of the aforementioned applications are often distributed among different devices in system 1.

The individual time ascertainment devices 17 transmit their time data TD to the reception buffer 18 of the time visualization device 10 (see FIG. 2). The time ascertainment devices 17 of the applications 12, 13, 14, 15, 16 each can send the time data TD as soon as new information is available. In this case, the individual applications 12, 13, 14, 15, 16 report the time information as soon as a patient is available in the particular “job queue” Furthermore, the time visualization device 10 can prompt via the appropriate time query signals the time ascertainment device 17 of the individual applications 12, 13, 14, 15, 16 to send the desired time data TD. In this manner, for example, the estimated duration of a complete CT examination can be requested for a specific patient. The time ascertainment devices 17 of the individual applications 12, 13, 14, 15, 16 deliver for this the process durations to Fe time visualization device 10. Each of the time ascertainment devices 17 can determine this duration based on different algorithms on their own. Thus, for example, the time ascertainment device 17 of an image acquisition application 12 learns the examination time based on similar exams that were previously performed. The time ascertainment unit 17 of a filming application 16 can calculate the number of desired film sheets with a constant transfer time per film sheet, etc.

As a whole, the time visualization device 10 can provide all necessary time Information on a patient and then summary it in the form of the desired time lapse plan. The prospective time estimate for the starting point of a specific work process as well as the duration of the respective work process naturally become more and more exact the more patients are in the respective job queue in front of the patient that we are interested in. In particular, the applications 12 are affected; these require a higher amount of user interaction and are therefore relatively hard to plan. This concerns for example, the image data capturing for CT examinations, since factor like emergencies or the age of the patients, e.g. whether the patient is a child or a senior, can play an important role. With such applications, the time estimates are thus preferably averaged over a higher number of previous examinations, in order to be able to provide the most statistically probable value.

Further options for improving the estimates consist, in particular, of improving processes, which concern the transfer of data over the network, determining network load and taking it into account during the estimation of the times. Additionally, all daily events are captured statistically on the Individual applications and are used to improve later time estimates. This means that the time durations estimated by the system and the time durations that occur in reality for the individual work processes are compared and analyzed. An analysis of this data over an extended period of time also offers the option of potentially adjusting the preset time as needed. In particular, non-deterministic times for patient data storage or for network transfer, which as a rule are dependent on different network loads, can also be corrected with this option.

FIG. 4 shows a further embodiment of a medical system 1 in accordance with the invention. However, in contrast to the system in FIG. 1, this system is designed in the form of a client-server system.

A central time visualization unit 10 is installed on a central server 8, which is also attached to the bus 2. The individual modalities 3, 4, 5, 6—which are incidentally the same modalities as in the embodiment in accordance with FIG. 1 or the workstation 7 each have only “simple” interfaces 20 in order to communicate with the time visualization device 10 and to transmit the time data obtained from the time ascertainment devices of the individual applications located on the different modalities 3, 4, 5, 6 to the time visualization device 10 on the central server.

The finished time lapse plan can be loaded via this interface 20 for graphical output on the monitors of the individual modalities 3, 4, 5, 6 or on a workstation 7 of server 8. Alternatively, the central time visualization device 10 can also be installed on a computer of the RIS 9 or on a workstation 7 or on a selected modal 3, 4, 5, 6 instead of on a separate server 8.

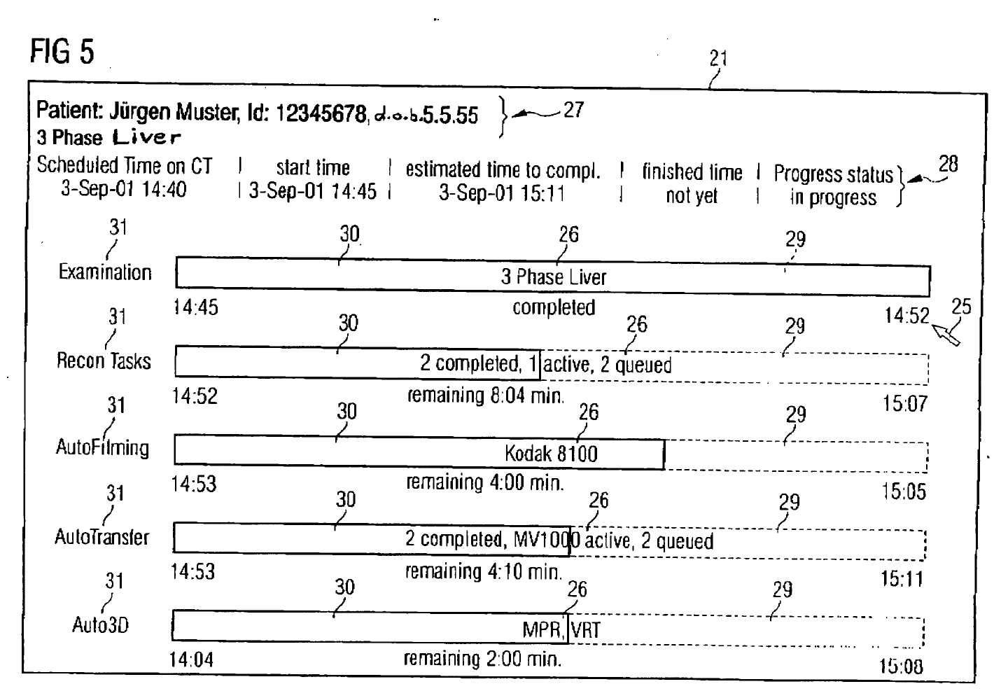

FIGS. 5 through 9 show examples of how a representation of the personal time lapse plan can be implemented on the display of a modality or a workstation monitor.

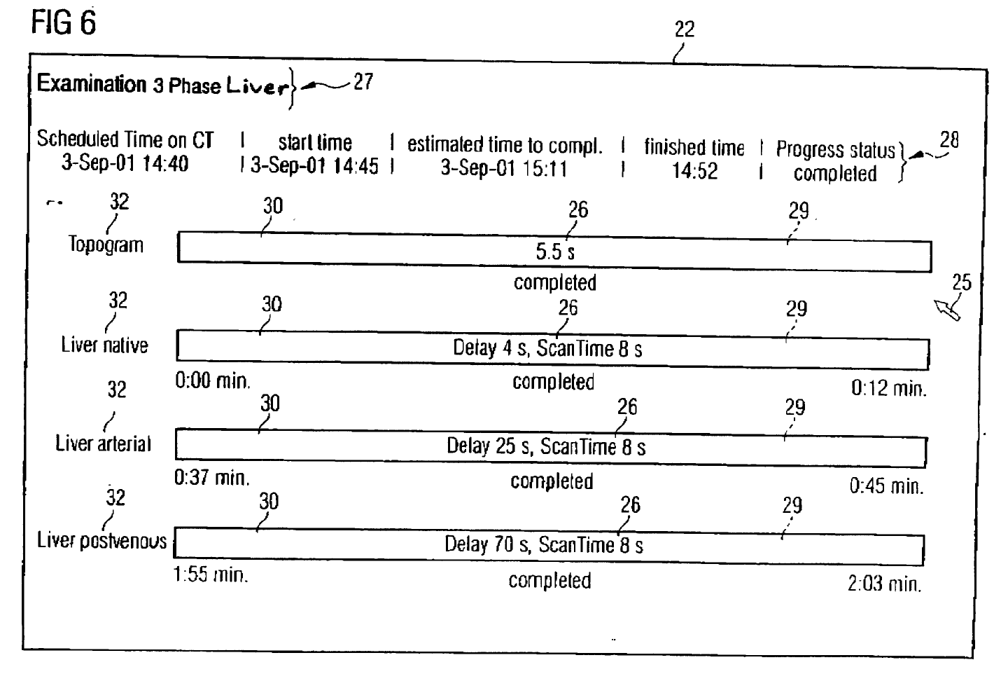

The representation preferably takes place on different graphical interfaces, with a graphical interface—generally, the initially displayed graphical interface—showing a complete overview over the examination process. Such an overview is depicted in FIG. 5. The FIGS. 6, 7, 8, and 9 each show additional graphical interfaces that contain detailed information on the individual work processes.

For example, FIGS. 5 through 9 assume a standard 3-phase liver examination of a patient. This concerns a computer-tomography examination of the liver in three phases (native=without the use of a contrast medium, arterial=1 through 20 seconds after the introduction of a contrast medium, post-venous=ca. 1 minute after the introduction of the contrast medium).

The graphical interface with the complete overview of the time lapse plan (FIG. 5) here shows a first header line block 27, in which the name, an ID number, and the date of birth of the patient as well as the type of examination are displayed in the upper area. The originally planned time on the respective modality (here, a computer tomography system). i.e. the time as of which the concerned computer-tomography machine is booked for this patient, is displayed in a second header line block 28 located below this. The actual start time of the examination as well as the subsequent estimated time is give behind this in order to close out the entire examination process Then the actual time is given at the end of the examinaton process. In this case, the examination is not yet done. The “Progress status” is given in the last area, where it can be seen whether the examination is still in progress.

The individual work processes are depicted clearly and concisely in the largest area of the graphical interface 21 located below the two header line blocks 27, 28. Each work process label 31 is given on the left, here “Examination” for the image data acquisition, “Recon Task” for the reconstruction of the image data, “AutoFilming” for an automatic filming of the image data, “AutoTransfer” for an automatic transfer of the image to a specific workstation, and “Auto3D” for a special post-processing of the data, for example for a multi-planar reconstruction (MPR) for the creation of thin-film images or for a creation of result images using the so-called Volume Rendering Technique (VRT). A horizontal bar field 29, in which a bar 30 corresponding to the already required time or the already completed portion of the work process runs from left to right, is located behind the work process labels 31.

Additional information can be provided in an information field 26 within the bar field 29. In this specific embodiment, the type of image capturing is set during the examination process. The indication that a total of two image series have already been completed, that an image series is being actively reconstructed, and that two image series are still located in the job queue is given during the reconstruction work process. The camera type—in this case, Kodak 8100— is given during the auto-filming. It is also given here during the auto-transfer that an image series has already been completely transferred and that a transfer to a specific viewing device —here an MV 100 (Magic View 1000)— is taking place and two image series remain to be transferred. The type of the post-processing, for example, MPR and VRT, is displayed here in the Auto3D work process.

The start time when the concerned work process was started is given to the far left under the bar field 29. In the center area, there is a note that the process has already been finished or alternatively the estimated remaining time of the work process. The estimated or actual finish time of the work process is given at the end.

As can be seen in FIG. 5, the image data acquisition is already completed in this specific example, i.e. the patient has already left the computer-tomography system. Right after the completion of the image data acquisition at 14:52, the reconstruction, auto-filming, and transfer of the picture via the network began. From the data already transmitted via the network, here a series of images, the Auto3D already started after receipt of the first data.

Using a mouse or other similar pointing device, the user always has the option of obtaining more detailed Information on the individual work processes by simply positioning a mouse pointer 25 on the work process label 31 or the appropriate bar field 29 and then clicking on the label or the field. A new window with a graphical interface then appears in which the individual work steps are displayed in a detailed manner within each work process, as in the overview in FIG. 5. Alternatively, the launching of additional graphical interfaces can also take place via another user interface, e.g. a keyboard.

A detailed graphical interface 22 is depicted in FIG. 6 for the “Examination” work process, i.e. the actual image data acquisition. This graphical interface 22 also contains a first header bar block 27, in Which here only the work process is described in greater detail, as well as a second header bar block 28. The first three positions of this second header bar block 28 contain the planned start time of the examination, the actual start time as well as the indication of the originally estimated time of the examination. The following field contains the time in which the respective work process was finished The last field gives the progress status of each work process. In this case, the concerned work process is already finished.

Below this, in the main field of the graphical interface 22, the individual work processes are given in the form of work process labels 32 on the left side and bar fields 29 arranged on the right with bars 20 running from left to right inside. The individual work processes here are the recording of a topogram, i.e. an overview recording for the graphical planning of the additional CT examination. Moreover; it concerns an image capturing of the liver in the native state, an image capturing of the liver in the arterial phase as well as image capturing of the liver in the post-venous phase Since all work processes have been completed here, the bars 30 completely fill the bar fields 29.

The start times are given at the beginning and the finish times are given at the end for each work process below the bar field 29. There is also a note in the middle that the concerned work process is finished. Additional information is again given inside the bar field 29. For the native capturing, for example, a delay time, here the time from the start of the respective image data acquisition to the actual beginning of the radiation exposure, is given. The individual time periods from the introduction of the contrast medium to the radiation exposure are given as the delay time in the bar for the arterial and post-venous image capturing. Moreover, each “scan time,” i.e. the total measured time for the capturing of each image, is given.

The user can return from this interface to the graphical interface 21 with the overview at any time, for example, by right-clicking or by pressing the “Esc” key on the keyboard.

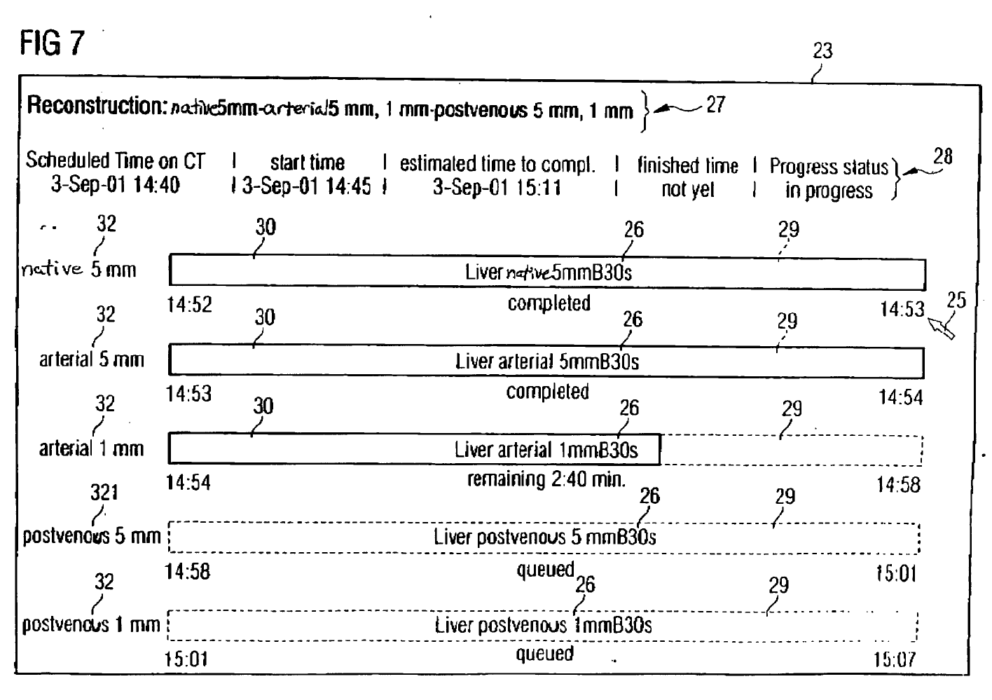

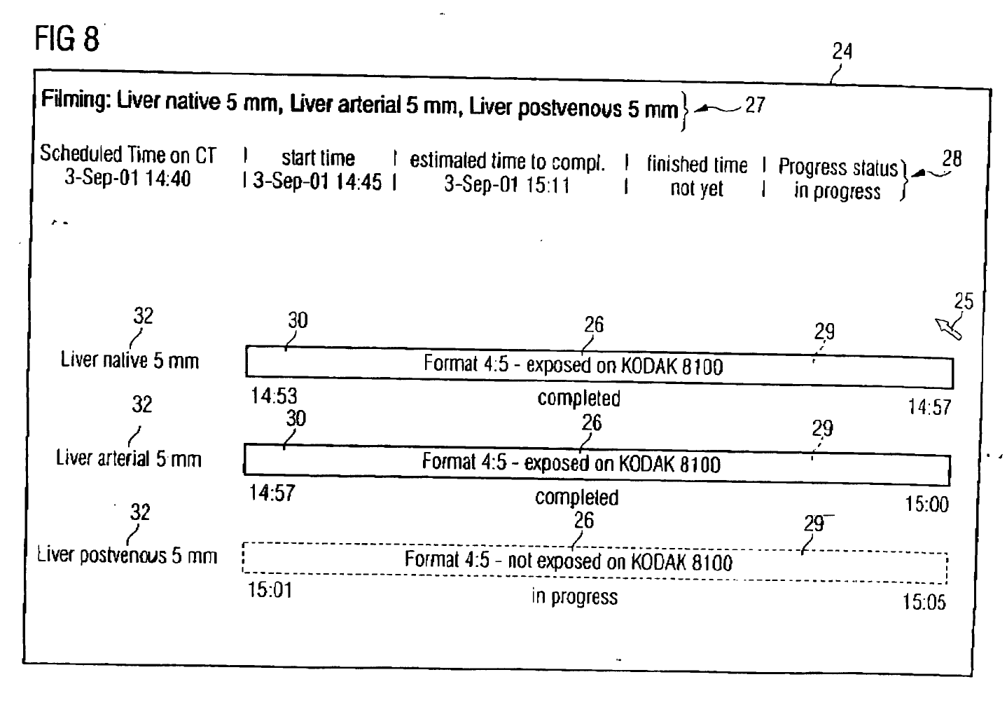

In the same manner as with the “Examination” work process, the other work processes can also be displayed on separate graphical Interfaces 23, 24 by clicking on the respective bar fields 29 in the overview 21. FIGS. 7 and 8 show further examples for the display of the detailed work steps in the “Reconstruction” and “Filming” work processes on two different graphical interfaces 23, 24.

The processing and graphical representation of the individual work steps within each work processes are designed with respect to the graphical interface 22 for the portrayal of the “Examination.”

In the embodiment depicted in FIG. 7, a 5-mm thick-film image of the liver in its native state, a mm thick-film image and a 1-mm thin-film image in the arterial phase, as well as a 5-mm thick-film image and a 1-mm thin-film image in the post-venous phase are created during the reconstruction. The thin-film images are each used in post-processing for an exact analysis of the blood vessel system.

This information Is represented as work step labels 32 as well as once more in the bar field 29. The B30s label here gives a specific reconstruction algorithm, with which the images are reconstructed, All of this information should only serve to clarify that all information useful to the operator can always be depicted in a suitable manner in direct reference to the respective work steps so that the operator can inform themselves at a glance about the course of the entire work process.

The embodiment in accordance with FIG. 7 shows that the native 5-mm and the arterial 5-mm reconstructions have already been completed. The system is currently working on processing the arterial 1-mm reconstruction The reconstruction of the post-venous thick-film and thin-film pictures is still in the job queue.

At the same time, a filming of the individual 5-mm film images is already being created. The graphical interface 24 associated with these work processes is shown in FIG. 8. As can be clearly recognized, the filming orders for the 5 mm native picture and the 5-mm arterial picture are already complete. The filming of the 5-mm post-venous picture can only begin once the reconstruction of this image has finished. The film format and the camera, with which the filming was performed, are given as additional information in the bar fields 29.

As the embodiments show, the Invention offers a relatively simple solution for determining a complete and expected time interval for a planned examination. Thus, not only the planned data for the examination and the actual measured duration after the completion of the examination are know, but also information on how long already started or later resumed work processes will take. A re-planning of an examination due to different circumstances like emergencies etc. as well as the associated time adjustments can be displayed immediately to clinical personnel so that they are not informed of the planning only after the delayed receipt of the patient images. Thus, measures can be taken early for further optimization of the workflow.

The systems and procedures in the figures and in the graphical interfaces are only embodiments that can be modified in many ways by those of ordinary skill within the framework of the invention.

For example, it is possible for the representation of the time lapse plans to be configured by a user him/herself as desired and that e.g. other pointers, pie charts, etc. are used instead of bars. A configuration is also possible in that certain processes are displayed to the respective user in a desired sequential order.

Moreover, the system can be expanded such that the graphical interface is simultaneously drawn on to control the workflow, in that for example re-prioritization of certain work processes can be performed by clicking on certain processes or work processes or by changing certain entries on the graphical interface. The user—insofar as he/she Is authorized to do so—can change concurrent activities in an uncomplicated manner. This only requires the linking of the graphical output with corresponding control programs for this type of medical system. Through this type of linking, a distribution center is made available to medical personnel, in which all actions for a patient are represented in a clear and concise manner and in which complete access to the workflow is possible in order to manually optimize the workflow for unexpected incidents or to adjust it based on occurring events.

Although modifications and changes . . .

I claim as my invention:

1. A method for monitoring medical examination or medical treatment activities for a specific patient, each comprising a plurality of different work processes performed in a medical system having a plurality of networked modalities, comprising the steps of:
associating a time ascertainment unit with each of said modalities and, in the time ascertainment unit for that modality, generating time data comprising a designation of at least one of a starting point and a duration of a planned work process occupying that modality, a designation of an estimated remaining time for said work process at said modality after said work process has begun at said modality, and a designation of completion of said work process at said modality; and
electronically automatically generating a personal time lapse plan for said specific patient from said time data generated by each of said time ascertainment units; and
graphically displaying said time lapse plan.

2. A method as claimed in claim 1 comprising generating and displaying said time lapse plan at a time visualization device, remote from said time ascertainment units, and supplying said time data from each of said time ascertainment units to said time visualization device.

3. A method as claimed in claim 2 comprising emitting an interrogation signal from said time visualization device to each of said time ascertainment units for initiating transmission of said time data to said time visualization device from the respective time ascertainment units.

4. A method as claimed in claim 2 comprising, if an error occurs at one of said modalities, logging an error status into the time ascertainment unit for that modality and transmitting said error status from the time ascertainment unit for the modality in which the error occurred to said time visualization unit.

5. A method as claimed in claim 1 comprising automatically electronically updating said time lapse plan at a plurality of different points in time.

6. A method as claimed in claim 1 comprising estimating at least one of said duration of said planned work process and said time of completion of said work process that has begun based on respective times required for a plurality of completed similar work processes.

7. A method as claimed in claim 1 comprising, In said graphical display of said time lapse plan, including an overview of a plurality of said work processes with displayed indications derived from said time data for each of said plurality of work processes.

8. A method as claimed in claim 1 comprising providing a plurality of display formats for graphically displaying said time lapse plan, respectively dependent on a type of said planned work process, and displaying said time lapse plan in said graphical display in a format corresponding to the planned work process.

9. A method as claimed in claim 1 wherein said modalities comprise respectively different modalities, and comprising providing a plurality of different formats for graphically displaying said time lapse plan, respectively for said different modalities, and graphically displaying said time lapse plan with a format corresponding to the modality on which said planned work process is performed.

10. A medical system comprising:
a plurality of different modalities for respectively performing different work processes on a patient, the respective work processes, in combination, forming an activity selected from the group consisting of medical examination activities and medical treatment activities;
a network connecting said modalities;
at each modality, a time ascertainment unit for determining time data for that modality comprising a designation of at least one of a starting point and a duration of a planned at work process for that modality, a designation of an estimated remaining time for completion of said work process at said modality after said work process has begun at said modality, and a designation of completion of the work process at that modality;
a time visualization device connected to said network for communicating via said network with said time ascertainment units for generating a time lapse plan for said patient from said time data; and
a display device in communication with said time visualization device for graphically displaying said time lapse plan.

11. A medical system as claimed in claim 10 comprising a central server connected to said network, and wherein said central server comprises said time visualization device.

12. A medical system as claimed in claim 10 comprising a plurality of further time visualization devices, respectively disposed at said plurality of different modalities, with each further time visualization device at each modality communicating with the time ascertainment unit at that modality.

13. A medical system as claimed in claim 10 wherein said time visualization device comprises a reception buffer for receiving said time data from said time ascertainment units, and a planning device connected to said reception buffer for sorting said time data.
